(19) United States
(12) Patent Application Publication
(10) Pub. No.: US 2005/0240748 A1
(43) Pub. Date: Oct. 27, 2005

(54) Locality-aware interface for kernal dynamic memory

(76) Inventor: Michael E. Yoder, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/832,758

(22) Filed: Apr. 27, 2004

(51) Int. Cl. G06F 12/00

(52) U.S. Cl. 711/170; 711/141

(57) ABSTRACT

Various approaches are described for allocating memory objects in a non-uniform memory access (NUMA) system. In one embodiment, at least one instance of a data structure of a first type is established to include a plurality of locality definitions. Each instance of the first type data structure has an associated set of program-configurable attributes that are used in controlling allocation of memory objects via the instance. Each locality definition is selectable via a locality identifier and designates a memory subsystem in the NUMA system. In response to a request from a processor in the NUMA system for allocation of memory objects via an instance of the first type data structure and specifying a locality identifier, memory objects are allocated to the requesting processor from the memory subsystem designated by the locality definition as referenced by the locality identifier.

### FIELD OF THE INVENTION

The present disclosure generally relates to memory allocation in NUMA systems.

### BACKGROUND

An advantage offered by Non-uniform Memory Access (NUMA) systems over symmetric multi-processing (SMP) systems is scalability. The processing capacity of a NUMA system may be expanded by adding nodes to the system. A node includes one or more CPUs and a memory subsystem that is local to the node and shared by all the CPUs across all nodes in the system. The nodes are coupled via a high-speed interconnection that relays memory transactions between nodes. The memory subsystems of all the nodes are shared by the CPUs in all the nodes.

One characteristic that distinguishes NUMA systems from shared memory systems with uniform memory access is that of local versus remote memories. Memory is local relative to a CPU if the CPU has access to the memory via a local bus within a node, and memory is remote relative to a CPU if the CPU and memory are in different nodes and access to the memory is via an inter-node interconnect. The access times between local and remote memory accesses may differ by orders of magnitude. Thus, the memory access time is non-uniform across the entire memory space.

A performance problem in a NUMA system may in some instances be attributable to how data is distributed between local and remote memory relative to a CPU needing access to the data. If a data set is stored in remote memory and a certain CPU references the data often enough, the latency involved in the remote access may result in a noticeable decrease in performance.

The memory that is allocated to the kernel of an operating system, for example, may be characterized as either static memory or dynamic memory. Static memory is memory that is established when the kernel is loaded. As long as the kernel executes the static memory is allocated to the kernel. Dynamic memory is memory is that requested by the kernel from the virtual memory system component of the operating system during kernel execution. Dynamic memory may be temporarily used by the kernel during execution and returned to the virtual memory system before kernel execution during execution and returned to the virtual memory system before kernel execution completes. Depending on the use of dynamically allocated memory, the locality of the referenced memory may affect system performance.

### SUMMARY

The various embodiments of the invention provide various approaches for allocating memory objects in a non-uniform memory access (NUMA) system. In one embodiment, at least one instance of a data structure of a first type is established to include a plurality of locality definitions. Each instance of the first type data structure has an associated set of program-configurable attributes that are used in controlling allocation of memory objects via the instance. Each locality definition is selectable via a locality identifier and designates a memory subsystem in the NUMA system. In response to a request from a processor in the NUMA system for allocation of memory objects via an instance of the first type data structure and specifying a locality identifier, memory objects are allocated to the requesting processor from the memory subsystem designated by the locality definition as referenced by the locality identifier.

It will be appreciated that various other embodiments are set forth in the Detailed Description and claims which follow.

### BRIEF DESCRIPTION OF THE DRAWINGS

FIG. 1 is a functional block diagram of an example Non-Uniform Memory Access (NUMA) system;

FIG. 2 illustrates localities in a NUMA system in accordance with various embodiments of the invention;

FIG. 3 is a functional block diagram that illustrates the interactions between components in an operating system in using the services of an arena allocator in allocating memory objects from various localities;

FIG. 4A is a block diagram of an arena data structure through which memory objects may be allocated from a single locality, such as interleave memory;

FIG. 4B is a block diagram of an arena data structure through which memory objects may be allocated from any locality other than the from the locality that is interleave memory;

FIG. 5 is a flowchart of an example process for allocating memory objects in accordance with various embodiments of the invention.

### DETAILED DESCRIPTION

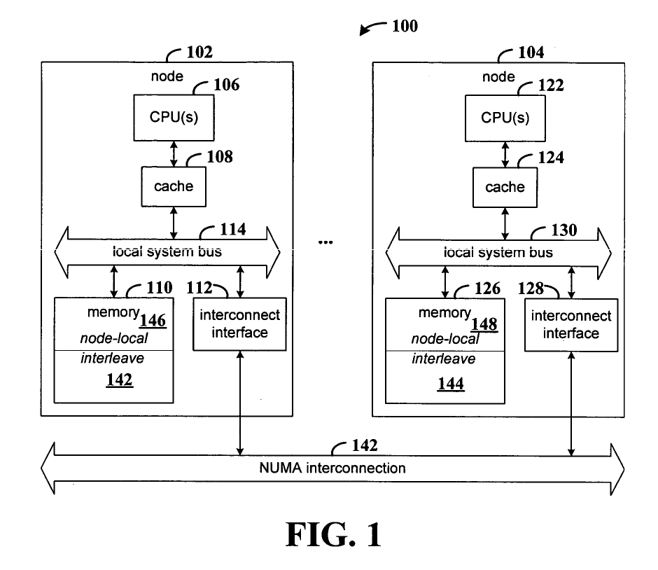

FIG. 1 is a functional block diagram of an example Non-Uniform Memory Access (NUMA) system 100. NUMA refers to a hardware architectural feature in modern multi-processor platforms that attempts to address the increasing disparity between requirements for processor speed and bandwidth capabilities of memory systems, including the interconnect between processors and memory. NUMA systems group CPUs, I/O busses, and memory into nodes that balance an appropriate number of processors and I/O busses with a local memory system that delivers the necessary bandwidth. The nodes are combined into a larger system by means of a system level interconnect with a platform-specific topology.

The example system 100 is illustrated with two nodes 102 and 104 of the multiple nodes in the system. Each node is illustrated with a respective set of components. Node 102 includes a set of one or more CPU(s) 106, a cache 108, memory subsystem 110, and interconnect interface 112. The local system bus 114 provides the interface between the CPUs 106 and the memory subsystem 110 and the interconnect interface 112. Similarly, node 104 includes a set of one or more CPU(s) 122, a cache 124, memory subsystem 126, and interconnect interface 128. The local system bus 130 provides the interface between the CPU(s) 122 and the memory subsystem 126 and the interconnect interface 128. The NUMA interconnection 142 interconnects the nodes 102 and 104.

The local CPU and I/O components on a particular node can access their own “local” memory with the lowest possible latency for a particular system design. The node may in turn access the resources (processors, I/O and memory) of remote nodes at the cost of increased access latency and decreased global access bandwidth. The term “Non-Uniform Memory Access” refers to the difference in latency between “local” and “remote” memory accesses that can occur on a NUMA platform. In the example system 100, an access request by CPU(s) 106 to node-local memory 146 is a local request and a request to node-local memory 148 is a remote request.

In an example NUMA system, the system's memory resources may include interleave memory and node-local memory. For example, each of memory subsystems 110 and 126 is illustrated with portions 142 and 144 for interleave memory and portions 146 and 148 for node-local memory. Objects stored in interleave memory are spread across the interleave memory portion in all the nodes in the NUMA system, and generally, an object stored in node-local memory is stored in the memory on a single node. System hardware provides and manages access to objects stored in interleave memory. An “object” may be viewed as some logically addressable portion of virtual memory space.

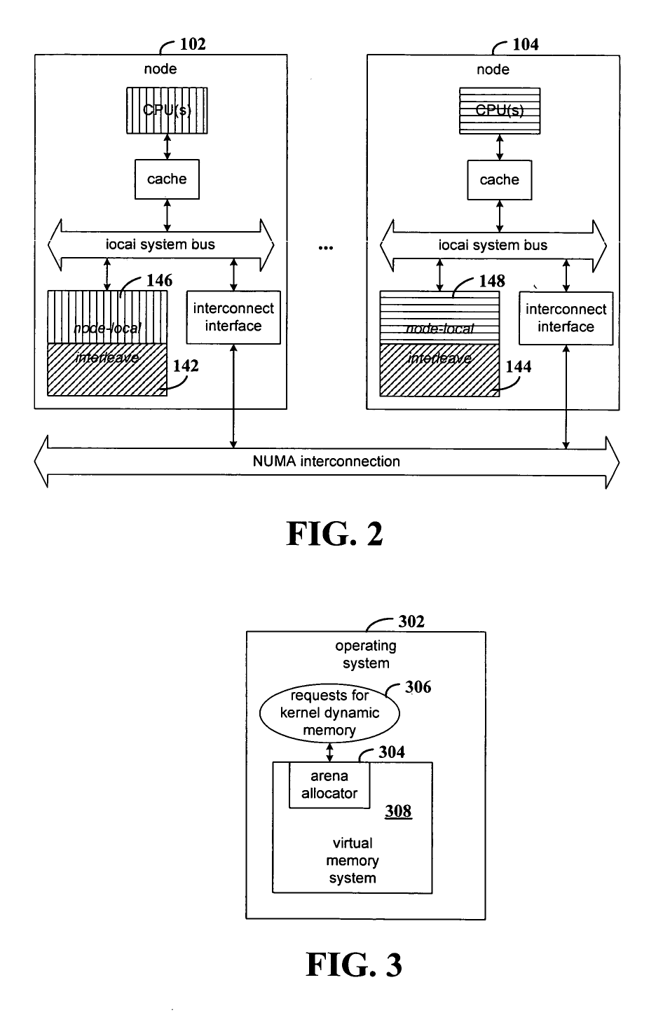

FIG. 2 illustrates localities in a NUMA system in accordance with various embodiments of the invention. In one embodiment of the invention, one locality is defined for interleave memory, and the node-local memory in the nodes defines other respective localities. The single interleave locality is illustrated by the diagonal hatch lines in interleave memory blocks 142 and 144. The locality in node-local memory 146 is illustrated by vertical hatch lines, and the locality in node-local memory 148 is illustrated by horizontal hatch lines. It will be appreciated that another NUMA system with n nodes may be implemented with no interleave memory, and therefore, n localities.

In various embodiments of the invention, a kernel request for dynamic memory may specify a particular locality from which memory is allocated. This may be beneficial for reducing memory access time and thereby improving system performance. For example, allocated dynamic memory may be heavily accessed by a certain CPU after the memory is allocated. Thus, in allocating the dynamic memory, it may be beneficial to request the memory from a locality that is local relative to the CPU requesting the allocation. In other cases the access to the dynamic memory may be infrequent enough that the locality may not substantially impact system performance. It will be appreciated that in other embodiments, the capability to request memory from a specific locality may be provided to application-level programs as well as the operating system kernel.

FIG. 3 is a functional block diagram that illustrates the interactions between components in an operating system 302 in using the services of an arena allocator 304 in allocating memory objects from various localities. Dynamic memory is allocated in response to kernel requests 306 issued from a particular CPU by way of the arena allocator 304, which is a component in the virtual memory system 308.

A virtual memory system generally allows the logical address space of a process to be larger than the actual physical address space in memory occupied by the process during execution. The virtual memory system expands the addressing capabilities of processes beyond the in-core memory limitations of the host data processing system. Virtual memory is also important for system performance in supporting concurrent execution of multiple processes.

In the various embodiments of the present invention, the virtual memory system 308 manages the memory resources in interleave memory and the node-local memory resources of the nodes in the system. The virtual memory system also includes an arena allocator 304 for allocating memory using common sets of attributes. In addition to the Arena Allocator found in the HP-UX from Hewlett-Packard Company, the slab allocator from SUN Microsystems, Inc. and the zone allocator used in the Mach OS are examples of attribute-based memory allocators.

The arena allocator 304 allows sets of attributes and attribute values to be established, with each set of attributes and corresponding values being an arena. Memory allocated through an arena has the attributes and attribute values of the arena. In one embodiment, example attributes include the memory alignment by which objects of different sizes are allocated, the maximum number of objects that may be allocated to the arena, the minimum number of objects that the arena should keep on free lists and available for allocation, maximum page size, and whether extra large objects are cached.

To use an arena for allocating memory, the kernel first creates an arena with the desired attributes. The arena allocator 304 returns an identifier that can be used to subsequently allocate memory through that arena. To allocate memory, the kernel submits a request to the arena allocator 304 and specifies the arena identifier along with a requested amount of memory. The arena allocator then returns a pointer to the requested memory if the request can be satisfied. It will be appreciated that depending on kernel processing requirements, many different arenas are likely to be created.

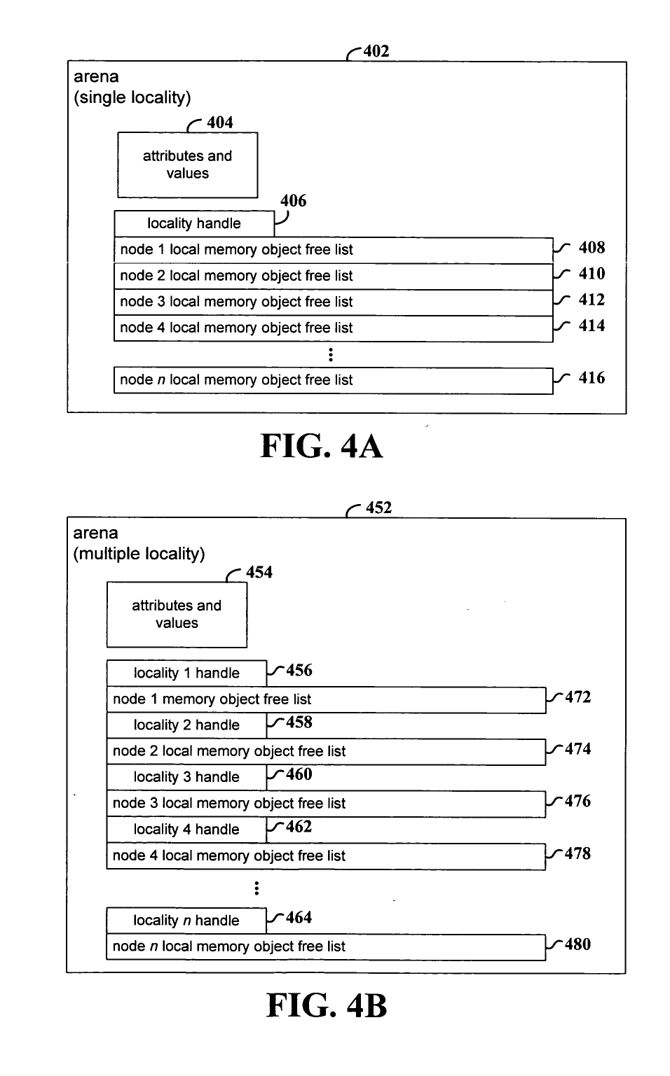

When called upon to create an arena, the arena allocator uses various data structures to manage the memory objects that are available for dynamic memory allocation. Some of the information used to manage arenas in support of the various embodiments of the invention is illustrated in FIGS. 4A and 4B below. An arena may be created with a single or multiple localities. A single locality arena may include interleave memory or node-local memory of a particular node. A multiple locality arena may be used to allocate node-local memory of any one of the nodes in the NUMA system.

FIG. 4A is a block diagram of an arena data structure 402 through which memory objects may be allocated from a single locality, such as interleave memory or the node-local memory of a single node. The data structure 402 may be made of one or more linked structures that include the previously described arena attributes and corresponding values (block 404), along with a locality handle 406 and respective free-lists 408, 410, 412, 414, and 416 for each node.

The locality handle 406 is used by the virtual memory system to identify a locality of memory in the NUMA system, either interleave memory or node-local memory of a node. The arena allocator 304 passes the locality handle to the virtual memory system 308 when the arena allocator requests memory from the virtual memory system.

For each node, the arena allocator 304 maintains a list of memory objects that are available for immediate allocation to a requesting CPU from that node. Initially, the free lists are empty. The arena allocator does not populate a free list for a node until an initial request for memory objects is submitted from a CPU from that node. In response, the arena allocator requests from the virtual memory system a number of objects according to the attributes of the arena. Some of the objects from the virtual memory system are added to the free list for the node having the requesting CPU, and other objects are returned to the requesting CPU to satisfy the allocation request. When there are sufficient memory objects available on a free list of a node and a CPU of that node submits an allocation request, the arena allocator returns memory objects from the free list.

FIG. 4B is a block diagram of an arena data structure 452 through which memory objects may be allocated from any locality other than interleave memory. Data structure 452 includes attributes and values 454 of the arena, respective locality handles 456, 458, 460, 462, and 464 for the localities of the node-local memory (FIG. 2), and respective free lists 472, 474, 476, 478, and 480 of memory objects associated with the nodes.

Each locality handle identifies the node-local memory for the virtual memory system. If a request to the arena allocator 304 specifies a locality from which memory is to be allocated, the arena allocator returns memory objects from the free list of the specified locality. Otherwise, if no locality is specified, the arena allocator looks to the free list for the node of the CPU from which the request was issued.

The arena allocator maintains a respective free list for each locality. The number of memory objects maintained on each free list is controlled by one of the arena attribute values 454. Memory objects are not added to a free list of a node until either a request is made for memory from the associated locality or a CPU from the node issues a request without specifying a locality.

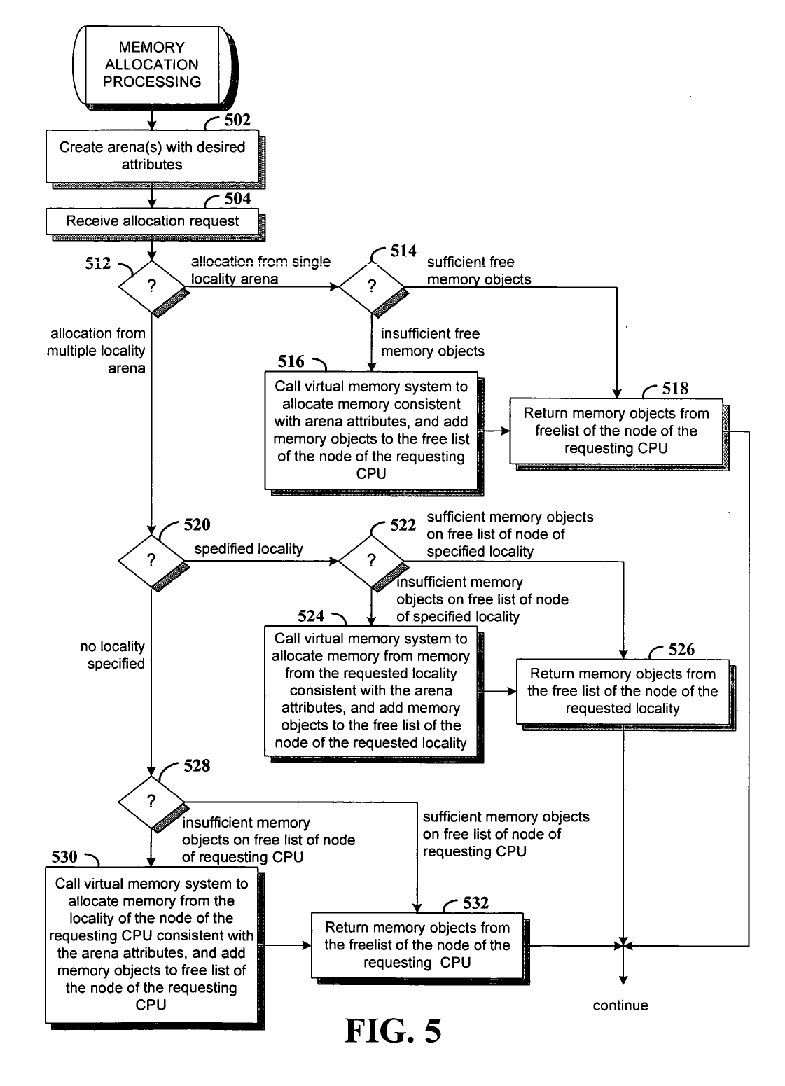

FIG. 5 is a flowchart of an example process for allocating memory objects in accordance with various embodiments of the invention. Before a memory request can be serviced, an arena must be created through which the memory can be allocated (step 502). An arena may be created by the arena allocator 304 in response to a request from the kernel. The attributes of an arena, as well as the number and types of arenas depend on the kernel's operating requirements and are established as specified by the kernel.

In establishing an arena, the arena allocator 304 uses parameter values specified by the kernel in the request. The parameter values are for the previously described arena attributes and in addition whether the arena has a single locality (FIG. 4A, 402) or multiple localities (FIG. 4B, 452). If a locality is specified in a request to create a single locality arena, the locality may reference either interleave memory or the node-local memory of one of the nodes in the NUMA system. If neither single nor multiple localities are specified in the request, the arena allocator by default creates a single locality arena, which refers to interleave memory.

In response to an allocation request, which specifies an arena (step 504), the arena allocator 304 determines whether the arena has a single or multiple localities (decision 512). For a single locality arena (FIG. 4A, 402), the arena allocator determines whether the free list of the node from which the request was submitted has a sufficient number of memory objects to satisfy the request (decision 514). If not, the arena allocator calls the virtual memory system to allocate objects from the single locality identified by the arena (step 516). As previously explained, the single locality may be either interleave memory or the node-local memory of a node. The arena allocator uses the arena attributes in making the request to the virtual memory system, and the memory objects obtained are added to the free list of the node from which the request was made. Once sufficient memory objects are on the free list of the node from which the request was made (or if there were already sufficient memory objects), the memory objects are removed from the free list and returned to the requesting CPU (step 518).

If the specified arena is a multiple locality arena (FIG. 4B, 452), the arena allocator determines whether the request specifies a locality from which to allocate memory (decision 520). If a locality is requested, the arena allocator determines whether the free list associated with the locality contains sufficient memory objects to satisfy the request (decision 522). If not, the arena allocator calls the virtual memory system to allocate objects from the specified locality (step 524). The arena allocator uses the arena attributes in making the request to the virtual memory system, and the memory objects obtained are added to the free list of the node of the specified locality. Once sufficient memory objects are on the free list of the node of the requested locality (or if there were already sufficient memory objects), the memory objects are removed from the free list and returned to the requesting CPU (step 526).

If no locality is specified (decision 520), the arena allocator determines whether there are sufficient memory objects on the free list of node of the requesting CPU (decision 528). If there are insufficient memory objects to satisfy the request, the arena allocator calls the virtual memory system to allocate objects from the locality of the node of the requesting CPU (step 530). The arena allocator uses the arena attributes in making the request to the virtual memory system, and the memory objects obtained are added to the free list of the node of the requesting CPU. Once sufficient memory objects are on the free list of the node of the requesting CPU (or if there were already sufficient memory objects), the memory objects are removed from the free list and returned to the requesting CPU (step 532).

Deallocating memory objects that are allocated through an arena may be performed with a deallocation request to the arena allocator 304. The deallocation request includes a reference to the memory object to be deallocated. When the memory object was allocated, the arena allocator stored in a header associated with the memory object the address of the free list from which the memory object was allocated. The arena allocator uses this previously stored address to return the memory object to the appropriate free list.

Those skilled in the art will appreciate that various alternative computing arrangements would be suitable for hosting the processes of the different embodiments of the present invention. In addition, the processes may be provided via a variety of computer-readable media or delivery channels such as magnetic or optical disks or tapes, electronic storage devices, or as application services over a network.

The present invention is believed to be applicable to a variety of systems that allocate dynamic memory and has been found to be particularly applicable and beneficial in allocating dynamic memory to the kernel in a NUMA system. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

1. A processor-implemented method for allocating memory objects in a non-uniform memory access (NUMA) system, comprising:
establishing at least one instance of a data structure of a first type including a plurality of locality definitions, wherein each instance of the first type data structure has an associated set of program-configurable attributes used in controlling allocation of memory objects via the instance of the first type data structure, and each locality definition being selectable via a locality identifier and designating a memory subsystem in the NUMA system;
in response to a request from a processor in the NUMA system for allocation of memory objects via the an instance of the first type data structure and specifying a locality identifier, allocating to the processor memory objects from the memory subsystem designated by the locality definition as referenced by the locality identifier.

2. The method of claim 1, wherein the NUMA system includes a plurality of nodes, and each node includes at least one processor coupled to a memory subsystem via a local bus, the method further comprising, in response to a request from a processor for allocation of memory objects via an instance of the first type data structure and not specifying a locality identifier, allocating to the processor memory objects from the memory subsystem that is in the node of the requesting processor.

3. The method of claim 2, further comprising:
establishing at least a first instance of a data structure of a second type including a single locality definition, wherein each instance of the second type data structure has an associated set of program-configurable attributes used in controlling allocation of memory objects via the first instance of the second type data structure, and the single locality definition of the first instance references a memory subsystem in a node; and
in response to a request from a processor in the NUMA system for allocation of memory objects via the first instance of the second type data structure, allocating to the processor memory objects from the memory subsystem referenced by the single locality definition consistent with attributes of the first instance of the data structure of a second type.

4. The method of claim 3, wherein the NUMA system includes an interleave memory, the method further comprising:
establishing at least a second instance of a data structure of the second type, wherein the single locality definition of the second instance references the interleave memory in the NUMA system; and
in response to a request from a processor in the NUMA system for allocation of memory objects via the second instance, allocating to the processor memory objects from interleave memory consistent with attributes of the second instance of a data structure of a second type.

5. The method of claim 2, wherein the NUMA system includes an interleave memory, the method further comprising:
establishing at least one instance of a data structure of the second type, wherein the single locality definition of the at least one instance references the interleave memory in the NUMA system; and
in response to a request from a processor in the NUMA system for allocation of memory objects via the at least one instance, allocating to the processor memory objects from interleave memory consistent with attributes of the at least one instance of a data structure of a second type.

6. The method of claim 4, further comprising:
maintaining in each instance of the first type and second type data structures, respective lists of free memory objects for each node in the NUMA system; and
wherein allocating memory objects from memory associated with an instance of a data structure of the second type includes removing memory objects from the list of free memory objects of the node having the requesting processor and providing the memory objects to the requesting processor.

7. The method of claim 6, wherein allocating memory objects via an instance of the first type data structure in response to a first request that specifies a locality identifier, includes removing memory objects from the list of free memory objects associated with the node designated by the locality definition identified by the locality identifier in the request.

8. The method of claim 7, wherein each request includes a requested amount of memory, the method further comprising, in response to a free list having an insufficient number of memory objects to satisfy the amount of memory specified in the first request, adding to the free list a selected number of memory objects from the memory subsystem designated by the locality designated in the first request.

9. The method of claim 8, wherein allocating memory objects via an instance of the first type data structure, in response to a second request that does not specify a locality identifier, includes removing memory objects from the list of free memory objects associated with the node having the requesting processor.

10. The method of claim 9, further comprising, in response to a free list having an insufficient number of memory objects to satisfy the amount of memory specified in the second request, adding to the free list a selected number of memory objects from the memory subsystem in the node of the processor making the second request.

11. The method of claim 10, further comprising, in response to a third request from a processor in the NUMA system for allocation of memory objects via a specified instance of the second type data structure and the free list having an insufficient number of memory objects to satisfy the amount of memory specified in the third request, adding to the free list associated with the processor making the third request a selected number of memory objects from memory associated with the single locality definition of the specified instance.

12. The method of claim 4, wherein in response to a request to create an instance of a data structure of the second type for controlling allocation of memory objects, and the request does not specify a locality identifier, establishing an instance of the second type data structure including a single locality definition that references interleave memory.

13. The method of claim 4, wherein in response to a request to create an instance of a data structure of the second type for controlling allocation of memory objects, and the request specifies a locality identifier that references a memory subsystem in one of the nodes, establishing an instance of the second type data structure including a single locality definition that references the memory subsystem in the one of the nodes.

14. A program storage medium, comprising:
a processor-readable device configured with instructions for allocating memory objects in a non-uniform memory access (NUMA) system, wherein execution of the instructions by one or more processors causes the one or more processors to perform operations including,
establishing at least one instance of a data structure of a first type including a plurality of locality definitions, wherein each instance of the first type data structure has an associated set of program-configurable attributes used in controlling allocation of memory objects via the instance of the first type data structure, and each locality definition being selectable via a locality identifier and designating a memory subsystem in the NUMA system;
in response to a request from a processor in the NUMA system for allocation of memory objects via the an instance of the first type data structure and specifying a locality identifier, allocating to the processor memory objects from the memory subsystem designated by the locality definition as referenced by the locality identifier.

15. The program storage medium of claim 14, wherein the NUMA system includes a plurality of nodes, and each node includes at least one processor coupled to a memory subsystem via a local bus, the operations further including, in response to a request from a processor for allocation of memory objects via an instance of the first type data structure and not specifying a locality identifier, allocating to the processor memory objects from the memory subsystem that is in the node of the requesting processor.

16. The program storage medium of claim 15, the operations further comprising:
establishing at least a first instance of a data structure of a second type including a single locality definition, wherein each instance of the second type data structure has an associated set of program-configurable attributes used in controlling allocation of memory objects via the first instance of the second type data structure, and the single locality definition of the first instance references a memory subsystem in a node; and
in response to a request from a processor in the NUMA system for allocation of memory objects via the first instance of the second type data structure, allocating to the processor memory objects from the memory subsystem referenced by the single locality definition consistent with attributes of the first instance of the data structure of a second type.

17. The program storage medium of claim 16, wherein the NUMA system includes an interleave memory, the operations further comprising:
establishing at least a second instance of a data structure of the second type, wherein the single locality definition of the second instance references the interleave memory in the NUMA system; and
in response to a request from a processor in the NUMA system for allocation of memory objects via the second instance, allocating to the processor memory objects from interleave memory consistent with attributes of the second instance of a data structure of a second type.

18. The program storage medium of claim 15, wherein the NUMA system includes an interleave memory, the operations further comprising:
establishing at least one instance of a data structure of the second type, wherein the single locality definition of the at least one instance references the interleave memory in the NUMA system; and
in response to a request from a processor in the NUMA system for allocation of memory objects via the at least one instance, allocating to the processor memory objects from interleave memory consistent with attributes of the at least one instance of a data structure of a second type.

19. The program storage medium of claim 17, the operations further comprising:
maintaining in each instance of the first type and second type data structures, respective lists of free memory objects for each node in the NUMA system; and
wherein allocating memory objects from memory associated with an instance of a data structure of the second type includes removing memory objects from the list of free memory objects of the node having the requesting processor and providing the memory objects to the requesting processor.

20. The program storage medium of claim 19, wherein allocating memory objects via an instance of the first type data structure in response to a first request that specifies a locality identifier, includes removing memory objects from the list of free memory objects associated with the node designated by the locality definition identified by the locality identifier in the request.

21. The program storage medium of claim 20, wherein each request includes a requested amount of memory, the operations further comprising, in response to a free list having an insufficient number of memory objects to satisfy the amount of memory specified in the first request, adding to the free list a selected number of memory objects from the memory subsystem designated by the locality designated in the first request.

22. The program storage medium of claim 21, wherein allocating memory objects via an instance of the first type data structure, in response to a second request that does not specify a locality identifier, includes removing memory objects from the list of free memory objects associated with the node having the requesting processor.

23. The program storage medium of claim 22, the operations further comprising, in response to a free list having an insufficient number of memory objects to satisfy the amount of memory specified in the second request, adding to the free list a selected number of memory objects from the memory subsystem in the node of the processor making the second request.

24. The program storage medium of claim 23, the operations further comprising, in response to a third request from a processor in the NUMA system for allocation of memory objects via a specified instance of the second type data structure and the free list having an insufficient number of memory objects to satisfy the amount of memory specified in the third request, adding to the free list associated with the processor making the third request a selected number of memory objects from memory associated with the single locality definition of the specified instance.

25. The program storage medium of claim 17, wherein in response to a request to create an instance of a data structure of the second type for controlling allocation of memory objects, and the request does not specify a locality identifier, establishing an instance of the second type data structure including a single locality definition that references interleave memory.

26. The program storage medium of claim 17, wherein in response to a request to create an instance of a data structure of the second type for controlling allocation of memory objects, and the request specifies a locality identifier that references a memory subsystem in one of the nodes, establishing an instance of the second type data structure including a single locality definition that references the memory subsystem in the one of the nodes.

27. A apparatus for allocating memory objects in a non-uniform memory access (NUMA) system, comprising:
means for establishing at least one instance of a data structure of a first type including a plurality of locality definitions, wherein each instance of the first type data structure has an associated set of program-configurable attributes used in controlling allocation of memory objects via the instance of the first type data structure, and each locality definition being selectable via a locality identifier and designating a memory subsystem in the NUMA system;
means, responsive to a request from a processor in the NUMA system for allocation of memory objects via the an instance of the first type data structure and specifying a locality identifier, for allocating to the processor memory objects from the memory subsystem designated by the locality definition as referenced by the locality identifier.

28. The apparatus of claim 27, further comprising:
means for establishing at least a first instance of a data structure of a second type including a single locality definition, wherein each instance of the second type data structure has an associated set of program-configurable attributes used in controlling allocation of memory objects via the first instance of the second type data structure, and the single locality definition of the first instance references a memory subsystem in a node; and
means, responsive to a request from a processor in the NUMA system for allocation of memory objects via the first instance of the second type data structure, for allocating to the processor memory objects from the memory subsystem referenced by the single locality definition consistent with attributes of the first instance of the data structure of a second type.

29. The apparatus of claim 28, wherein the NUMA system includes an interleave memory, further comprising:
means for establishing at least a second instance of a data structure of the second type, wherein the single locality definition of the second instance references the interleave memory in the NUMA system; and
means, responsive to a request from a processor in the NUMA system for allocation of memory objects via the second instance, for allocating to the processor memory objects from interleave memory consistent with attributes of the second instance of a data structure of a second type.
